(19) United States
(12) Patent Application Publication
(10) Pub. No.: US 2015/0025700 A1
(43) Pub. Date: Jan. 22, 2015

(54) APPARATUS AND METHOD REMOTELY MONITORING BUILDING STATE

(71) Applicant: ELECTRONICS AND TELECOMMUNICATIONS RESEARCH INSTITUTE, Daejeon (KR)

(72) Inventors: Chang-Sic CHOI, Daejeon (KR); Wan Ki PARK, Daejeon (KR); Youn Kwae JEONG, Daejeon (KR); IL Woo LEE, Daejeon (KR)

(73) Assignee: ELECTRONICS AND TELECOMMUNICATIONS RESEARCH INSTITUTE, Daejeon (KR)

(21) Appl. No.: 14/088,583

(22) Filed: Nov. 25, 2013

(30) Foreign Application Priority Data
Jul. 18, 2013 (KR) 10-2013-0085017

(51) Int. Cl. G05B 13/02

(52) U.S. Cl. CPC G05B 13/02
USPC 700/291

(57) ABSTRACT

An apparatus for monitoring a building state, the apparatus comprising: a receiver configured to receive state data of a building from a plurality of sensors that are used to measure a building state; a state database configured to store the state data; a reference database configured to store a reference to determine whether the state data are abnormal; a security determining unit configured to extract abnormal data determined to be in an abnormal scope among the state data; and an abnormal database configured to store the abnormal data.

### RELATED APPLICATIONS

This application claims the benefit of Korean Patent Application No. 10-2013-0085017, filed on Jul. 18, 2013, which is hereby incorporated by reference as if fully set forth herein.

### FIELD OF THE INVENTION

The present invention relates to an apparatus and method for remotely monitoring a building state. More specifically, the present invention relates to an apparatus and method, capable of immediately arranging for maintenance to a failure occurrence or a short circuit situation while efficiently managing energy consumed by kinds of facilities in a building, by informing a manager of the building immediately when state data received from a plurality of building facilities are out of a reference value or a normal pattern.

### BACKGROUND OF THE INVENTION

Recently, as low-carbon green growth policies, increase in world energy expense, national and international major power outages and safety of nuclear power generation are becoming serious issues, efficient building management services are required in terms of energy.

Although technical measures to manage building energy were made, it is not easy to expect effects when there is not careful and continuous energy management for energy use type, system efficiency and normal operation of a certain building. Particularly, services are needed to make a correct monitoring for failed states, short circuit and excessive energy consumption of building facilities.

However, typical building remote meter reading systems can provide the amount of entire energy consumption for monthly charging or a reporting function for a direct failure occurrence state of building facilities, but they cannot provide the amount of electricity use separated in each load and the amount of energy use that is out of a reference value or a normal pattern.

Further, while the building remote meter reading systems need a manager to manage failure states of building facilities and the amount of energy use when it is out of a reference value or a normal pattern, it is very difficult for the manager to monitor and manage all facilities when there are hundreds or thousands of facilities.

Accordingly, there is needed a monitoring system to immediately meet a situation where state data provided from a plurality of building facilities are out of a reference value or a normal pattern or the like.

### SUMMARY OF THE INVENTION

In view of the above, the present invention provides all solutions to the above described problems.

Further, the present invention provides an apparatus and method for immediately reporting a manger of a building of a situation that state data provided from a plurality of building facilities are out of a reference value or a normal pattern.

In accordance with an embodiment of the present invention, there is provided an apparatus for monitoring a building state, which includes: a receiver configured to receive state data of a building from a plurality of sensors that are used to measure a building state; a state database configured to store the state data; a reference database configured to store a reference to determine whether the state data are abnormal; a security determining unit configured to extract abnormal data determined to be in an abnormal scope among the state data; and an abnormal database configured to store the abnormal data.

In the embodiment, wherein the reference database further comprises an allowed minimum reference and an allowed maximum reference predetermined for the state data; wherein the security determining unit further comprises an error verifying unit to determine an error when the state data are less than the allowed minimum reference or exceed the allowed maximum reference; and wherein the abnormal database further comprises error data determined to be erroneous among the state data.

In the embodiment, wherein the security determining unit further comprises an error number calculator to calculate an accumulated error number that the state data are determined as error data; and wherein the abnormal database further comprises the accumulated error number.

In the embodiment, wherein the reference database further comprises a monitoring period which monitors whether the state data are received; wherein the security determining unit comprises loss number accumulating unit to calculate an accumulated loss number, the accumulated loss number being the number of state data that are not received within the monitoring period; and wherein the abnormal database further comprises the accumulated loss number.

In the embodiment, further comprising a security output unit to transmit at least one of the error data and the accumulated error number stored in the abnormal database to a manager of the building.

In the embodiment, wherein the reference database further comprises an allowed loss time indicating a maximum value in which the accumulated loss number are permitted; and wherein the security determining unit further comprises a loss number verifying unit which determines whether the accumulated loss number exceed the allowed loss number.

In the embodiment, wherein the allowed loss number are differently decided depending on at least one period.

In the embodiment, wherein at least one of the allowed minimum reference and the allowed maximum reference is added, deleted or changed based on a predetermined process.

In the embodiment, wherein at least one of the monitoring period or allowed loss number is added, deleted or changed based on a predetermined process.

In the embodiment, wherein the state data comprises at least one of building facility state information, building interior and exterior environment information, and building consumed energy pattern information.

In accordance with an embodiment of the present invention, there is provided a method for monitoring a building state, which includes: receiving state data of a building from a plurality of sensors that are used to measure a building state; constructing a state database configured to store the state data; constructing a reference database configured to store a reference to determine whether the state data are abnormal; determining a security to extract abnormal data determined to be in an abnormal scope among the state data; and constructing an abnormal database configured to store the abnormal data.

In the embodiment, wherein the reference database further comprises an allowed minimum reference and an allowed maximum reference predetermined for the state data; wherein said determining a security further comprises determining an error when the state data are less than the allowed minimum reference or exceed the allowed maximum reference; and wherein the abnormal database further comprises error data determined to be erroneous among the stat data.

In the embodiment, wherein said determining a security further comprises calculating an accumulated error number, which determine the state data as error data; and wherein the abnormal database further comprises the accumulated error number.

In the embodiment, wherein the reference database further comprises a monitoring period which monitors whether the state data is received; wherein said determining a security further comprises accumulating loss number to calculate an accumulated loss number, the accumulated loss number being the number of the state data that are not received within the monitoring period; and wherein the abnormal database further comprises the accumulated loss number that is accumulated in the accumulating loss number.

In the embodiment, further comprising transmitting at least one of the error data and an accumulated error number stored in the abnormal database to a manager of the building.

In the embodiment, wherein the reference database further comprises an allowed loss number indicating a maximum value in which the accumulated loss number is permitted; and wherein said determining a security further comprises determining whether the accumulated loss number exceeds the allowed loss number.

In the embodiment, wherein the allowed loss number is differently decided depending on at least one period.

In the embodiment, wherein at least one of the allowed minimum reference and the allowed maximum reference is added, deleted or changed based on a predetermined process.

In the embodiment, wherein at least one of the monitoring period or the allowed loss number is added, deleted or changed based on a predetermined process.

In the embodiment, wherein the state data comprises at least one of building facility state information, building interior and exterior environment information, and building consumed energy pattern information.

According to the present invention, since it is possible to immediately report a building manager of a situation that state data provided from a plurality of building facilities are out of a reference value or a normal pattern, building facilities and building energy consumption can be effectively managed by making a failure occurrence or a short circuit immediately arranged for maintenance.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of a configuration of a building state monitoring apparatus in accordance with an exemplary embodiment of the present invention;

FIG. 2 is a conceptual diagram illustrating a state database and a reference database in accordance with an exemplary embodiment of the present invention;

FIG. 3 is a block diagram of a security determining unit in accordance with an exemplary embodiment of the present invention;

FIG. 4 is a conceptual diagram illustrating a process to determine whether state data are error data in accordance with an exemplary embodiment of the present invention;

FIG. 5 is a conceptual diagram illustrating a process to calculate the number determined to be erroneous in accordance with an exemplary embodiment of the present invention;

FIG. 6 is a conceptual diagram illustrating a process to calculate and output the number of times that state data was lost in accordance with an exemplary embodiment of the present invention;

FIGS. 7A and 7B are conceptual diagrams illustrating profiles used in a reference database in accordance with an exemplary embodiment of the present invention; and

FIG. 8 is a flowchart illustrating a building state monitoring process in accordance with an exemplary embodiment of the present invention.

### DETAILED DESCRIPTION OF THE EMBODIMENTS

Detailed description of the present invention will be described below with reference to the accompanying drawings illustrating specific embodiments of the present invention. These embodiments are described in detail so that those skilled in the art can easily practice the present invention. It should be understood that the various embodiments of the present invention are different from each other, but need not be mutually exclusive. For example, a particular shape, structure and properties that are described herein and are related to one embodiment of the present invention may be implemented with other embodiments without departing the scope of the present invention. Further, it should be understood that the position and arrangement of the individual components in the embodiments may be changed without departing the scope of the present invention. Therefore, the detailed description below is rather than those that try to take as a limiting sense if it is explained properly, the scope of the present invention is only limited by all ranges identical to those that it claims, but the appended claims similar reference numerals refer to the same or similar elements throughout the drawings.

Hereinafter, embodiments of the present invention will be described in detail with reference to the accompanying drawings so that they can be readily implemented by those skilled in the art.

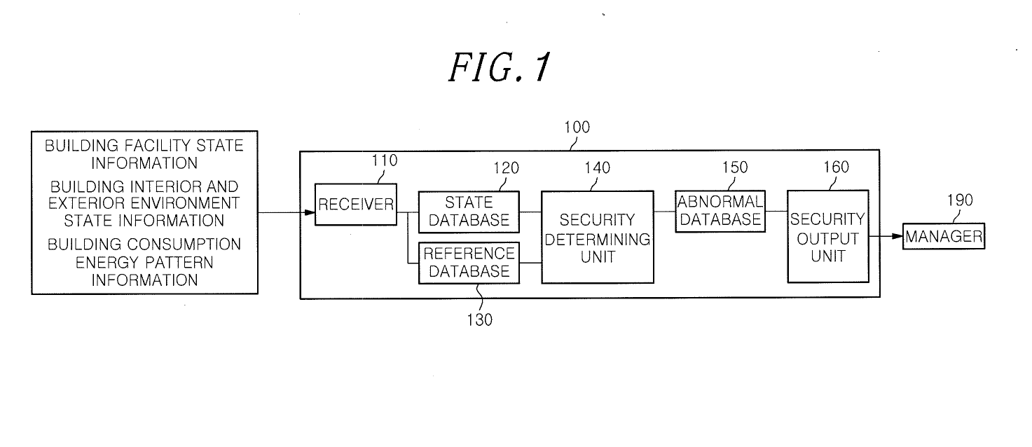

FIG. 1 is a block diagram illustrating a configuration of a building state monitoring apparatus in accordance with an exemplary embodiment of the present invention.

Referring to FIG. 1, a building state monitoring apparatus 100 in accordance with an exemplary embodiment of the present invention comprises a receiver 110 configured to receive state data including building facility state information, building interior and exterior environment state information or building consumption energy pattern state information, a state database 120 constructed based on the received state data, a reference database 130 configured to provide a reference to determine whether the state data are abnormal, a security determining unit 140 configured to determine the state data as abnormal data by comparing the state data with the reference, an abnormal database 150 configured to store the abnormal data, and a security output unit 160 configured to output the abnormal data to a building manager 190.

First, the receiver 110 receives state data of a building. To put it concretely, the state data may include at least one of building facility state information indicating states of building facilities (cooling/heating system, illumination, electrical power, for example), building interior and exterior environment state information indicating building interior and exterior environments (temperature, humidity, illuminance, air quality, for example), and state information of building consumption energy (consumption energy of an entire building, each floor, each section, each office, and each load, for example). Such state data is transmitted to a receiver 110 of the building state monitoring apparatus 100 from building facilities through wired and wireless communication interfaces (not illustrated in the drawing).

The state database 120 stores state data received from the receiver 110 and provides it to the security determining unit 140. The reference database 130 stores a reference to determine whether the state data are abnormal and provides the reference to the security determining unit 140. The security determining unit 140 determines whether the state data in the state database 120 are abnormal based on the reference database 130.

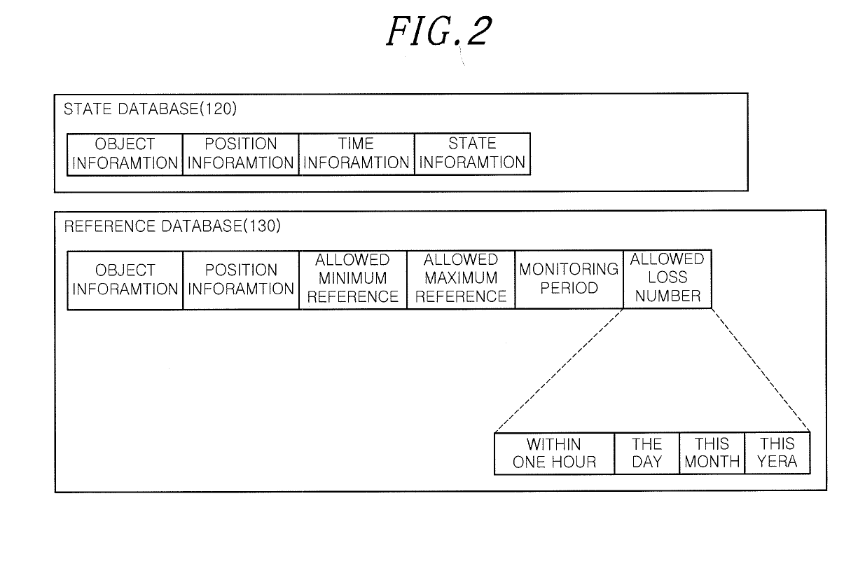

Structures of the state database 120 and reference database 130 will be described with reference to structures of a state database and a reference database of FIG. 2 in accordance with an exemplary embodiment of the present invention.

Referring to FIG. 2, a state database 120 includes object information, position information, time information or state information.

The object information includes information about an object that has transmitted the state data. For example, it may be the amount of electricity use on the 6th floor, boiler feed water temperature on 3rd floor, and so on. The position information indicates a detailed position of the object, the time information indicates a time point when the state data are measured, and the state information indicates a detailed value of the state data. For example, the position information may be a 6th floor or a rooftop. The time information may be five-thirty or eighteen-twenty one. The state information may be thirty degrees Centigrade, 17%, 300 kWh.

By the way, while the time information may be transmitted together with the state information by an object, it may be a time point when the building state monitoring apparatus received the state information.

As such, the state database 120 stores the state information received from a specific object as a type including object information, position information and time information about the object, and provides them to the security determining unit 140.

Meanwhile, a reference database 130 includes object information, position information, a predetermined allowed minimum reference, a predetermined allowed maximum reference, a monitoring period, or an allowed number of losses.

The allowed minimum reference and the allowed maximum reference are used as the references to verify whether the state is out of a reference value or a normal pattern, the monitoring period is a time interval to check whether the state data are received, and the allowed loss number means a maximum value in which a loss of the state data is permitted. For example, the allowed minimum reference and the allowed maximum reference may be three degrees Centigrade and fifty degrees Celsius, respectively, the monitoring period may be one minute and the allowed loss number may be 5.

Further, the reference database 130 may be added, deleted or changed by a manager or a process programmed in advance when building facilities or environment states are changed.

As such, the reference database 130 provides the security determining unit 140 with a reference to determine whether the state data are out of a reference value or a normal pattern and whether the state data are lost.

Although FIG. 2 illustrates that the state database 120 includes object information, position information, time information and state information, and the reference database 130 includes object information, position information, allowed minimum reference, allowed maximum reference, monitoring period, and allowed loss number, the databases may further include other information or may not include some of the information listed above according to the need of those skilled in the art.

Further, although it is illustrated that the state database and reference database are constructed separately in FIGS. 1 and 2 and drawing below, the state database and reference database may be integrally constructed in one database according to the need of those skilled in the art.

Referring to FIG. 1 again, the security determining unit 140 performs a function to compare state data provided from the state database 120 with a reference provided from the reference database 130 to determine the state data as abnormal data. More specifically, the security determining unit 140 determines whether the state data is out of a reference value or a normal pattern, that is, whether the state data is error data. Further, the security determining unit 140 determines the number of times that the state data are determined as error data, or determine whether the state data is lost or exceeds the maximum loss number that is a maximum allowed value of the loss number. Detailed description of each function will be made below.

The abnormal database 150 stores abnormal data that the security determining unit 140 determines to be abnormal. More specifically, the abnormal database 150 includes at least one of error data that is out of a reference value or a normal pattern among the state data, accumulated error number that is indicative of the number of times determined to be error data, or accumulated loss number that is indicative of the number of times that the state data are lost.

When analyzing data stored in the abnormal database 150, it is possible to detect data that is out of a reference value or a normal pattern. Therefore, it is possible to determine whether a specific facility is reduced in its performance or erroneously operates or determine an energy waste situation as time passes. Further, since it is possible to know a data loss level, a communication state between an object and a building state monitoring apparatus can also be determined accordingly.

The security output unit 160 outputs the abnormal data to the building manager 190. More specifically, the security output unit 160 provides at least one error data, the number of times determined to be error data and the accumulated loss number that exceeds an allowed loss number to the building manager 190. Accordingly, the building manager may be immediately reported a failure occurrence or a short circuit situation and rapidly arrange for maintenance, thereby managing the building efficiently.

However, although it is illustrated in FIG. 1 that the security output unit 160 is included in the building state monitoring apparatus 100, the security output unit 160 may not be included in the building state monitoring apparatus 100 according to the need of those skilled in the art.

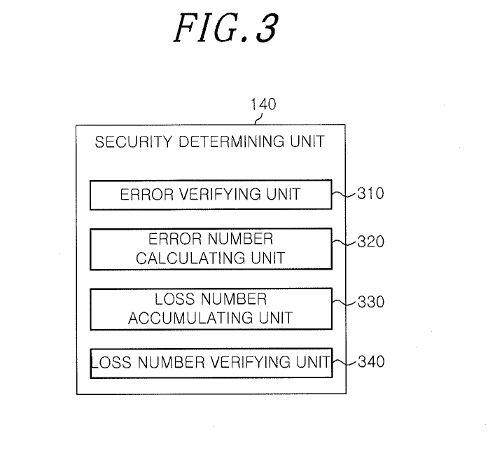

FIG. 3 is a block diagram of a construction of a security determining unit in accordance with an exemplary embodiment of the present invention.

Referring to FIG. 3, the security determining unit 140 includes an error verifying unit 310, an error number calculating unit 320, a loss number accumulating unit 330 or a loss number verifying unit 340.

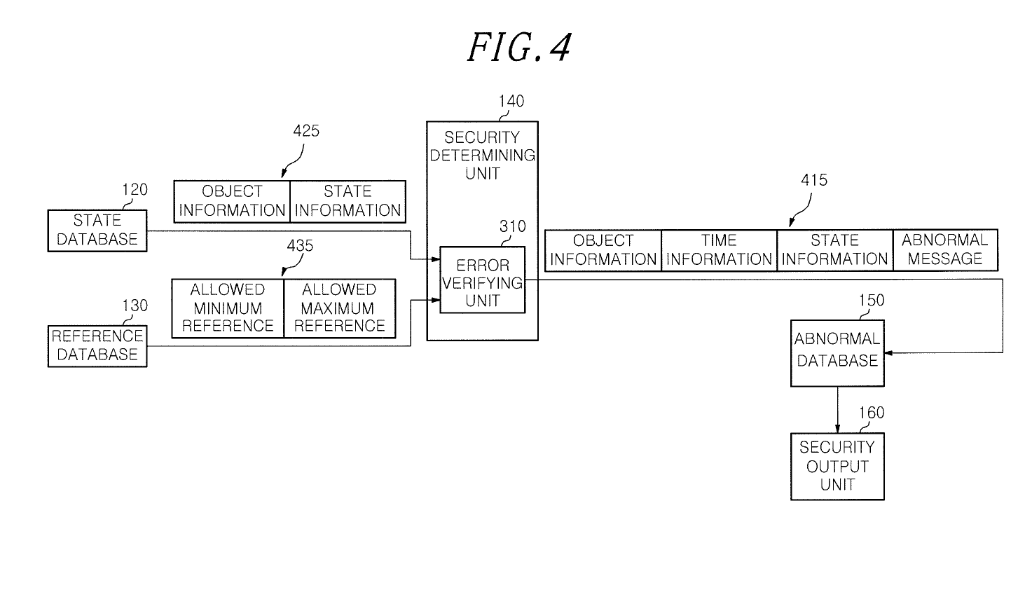

First, the error verifying unit 310 performs a function to verify whether building state data are out of a reference value or a normal pattern, and a detailed process of the verifying function will be described below with reference to FIG. 4.

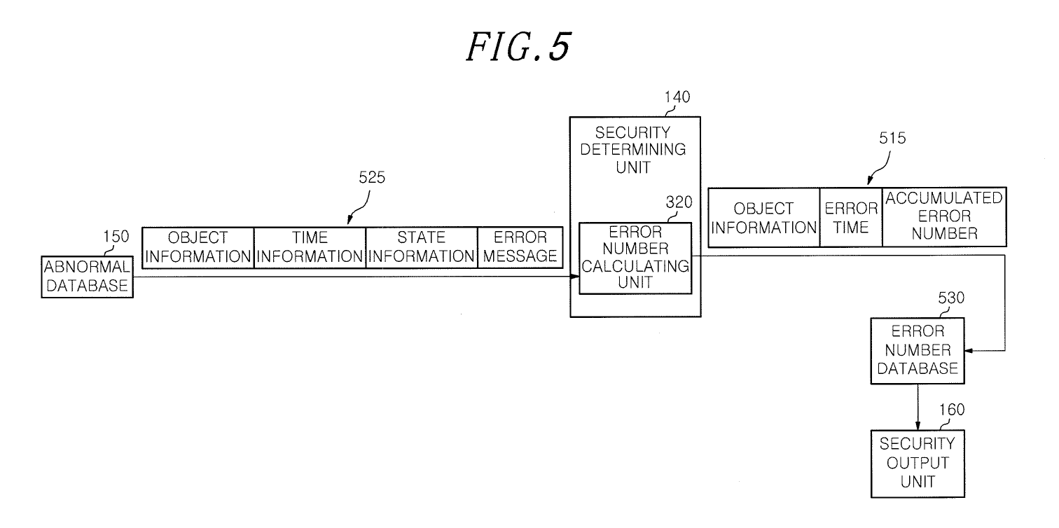

Next, the error number calculating unit 320 performs a function to calculate an accumulated error number generated when the error verifying unit 310 determined the building state data to be error data, and detailed process of the calculating function will be described below with reference to FIG. 5.

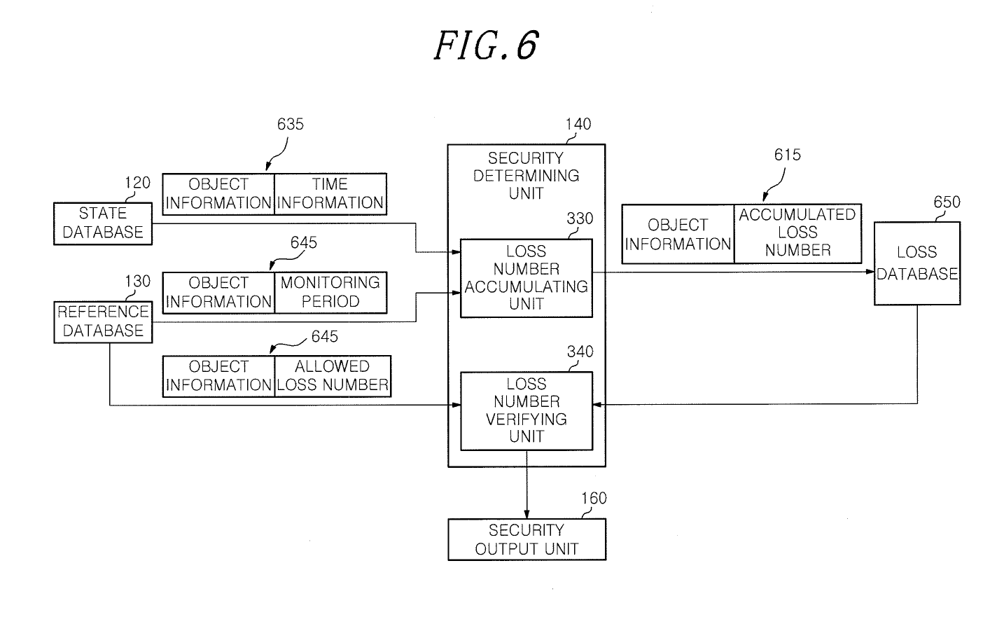

Finally, the loss number accumulating unit 330 determines whether the building state data were received within a monitoring period that is a predetermined time, and performs a function to calculate the accumulated loss number in which the state data is lost. The loss number verifying unit 340 performs a function to verify whether the accumulated loss number exceeds the allowed loss number that is an allowed maximum value that the loss number is permitted. Detailed process thereof will be described below with reference to FIG. 6.

FIG. 4 is a conceptual diagram illustrating a process to determine whether state data is error data in accordance with an exemplary embodiment of the present invention.

Referring to FIG. 4, the error verifying unit 310 included in the security determining unit 140 determines an error when object information and state information 425 provided from the state database 120 are less than an allowed minimum reference that is provided from the reference database 130 or exceed an allowed maximum reference 435.

When determined to be an error, the security determining unit 140 generates error data 425. More specifically, the security determining unit 140 includes time information indicating timing point when an error occurred based on object information received from the state database 140, state information determined to be an error, and an error message that indicates an error type. In more detail, the error message may be “exceeding” when the state information exceeds an allowed maximum reference and “shortfall” when the state information is less than an allowed minimum reference.

The generated error data 425 is then provided to the abnormal database 150, and presented to the manager through a security output unit 160. For example, when consumption energy in an office on the 3rd floor of the building exceeds an allowed maximum reference, information “office on the 3rd floor, 08:00, 30 kWh, exceeding” may be output to the manager through the security output unit 160. Accordingly, the manager may immediately take an action to the relevant object; and therefore, it is possible to manage consumption energy of the building efficiently.

FIG. 5 is a conceptual diagram illustrating a process to calculate the number determined to be erroneous in accordance with an exemplary embodiment of the present invention.

Referring to FIG. 5, the error number calculating unit 320 included in the security determining unit 140 calculates the accumulated error number for each object, based on error data 525 including object information, time information, state information and error message provided from the abnormal database 150.

The security determining unit 140 then generates the number-counting data 515 including object information, an error number and an accumulated error number. More specifically, the object information is information about an object in which an error occurs, the error time is a timing point when an error occurs, and the accumulated error number is the number of errors occurring for each object.

The number-counting data 515 generated is provided to the error number database 530, and the security output unit 160 output it to the manager. For example, when the temperature value of a temperature sensor exceeds the allowed maximum reference at 8 o'clock A.M., the number-counting data of “temperature sensor, 08:00, exceeding” may be generated and stored in the abnormal database 150, and then presented to the manager through the security output unit 140. Accordingly, the manager may immediately take an action to the relevant object and thus it is possible to manage building interior and exterior environment states efficiently.

Further, although it is illustrated in FIG. 5 that the number-counting data 515 were stored in the error number database 530, the number-counting data 515 may be stored in the abnormal database 150 in FIG. 4 without constructing the error number database 530 separately.

FIG. 6 is a conceptual diagram illustrating a process to calculate and output state data loss number in accordance with an exemplary embodiment of the present invention.

Referring to FIG. 6, the loss number accumulating unit 330 included in the security determining unit 140 performs a function to compare time information 635 for each object provided from the stage database 120 with a monitoring period 645 for each object provided from the reference database 130, determine whether new state data is not received within the monitoring period 645, and calculate “accumulated loss number” that were not received. In addition, the loss number verifying unit 340 has a function to verify whether the accumulated loss number exceeded an allowed loss number 647 for each object provided from the reference database 130.

First, the loss number accumulating unit 330 determines whether state data was received during the monitoring period. When the state data were not received during the monitoring period, it is determined to be “lost” and accumulated loss number is calculated. The loss number accumulating unit 330 may include loss data 615 including object information and accumulated loss number. The loss data 615 generated is provided to the loss database 650 and the loss database 650 stores the loss data 615.

The loss number verifying unit 340 performs a function to verify whether the accumulated loss number exceeds the allowed loss number. In this case, the accumulated loss number may be different depending on the objects.

For example, when the accumulated loss number of a first sensor is 3, and allowed loss number of the first sensor is 2, the loss number verifying unit 340 determines that the accumulated loss number exceeds the allowed loss number. However, when the accumulated loss number of a second sensor is 3 and allowed loss number of the second sensor is 4, the loss number verifying unit 340 determines that the accumulated loss number does not exceed allowed loss number.

The accumulated loss number determined to exceed may be provided to the manager through the security output unit 160. The large accumulated loss number may mean that it is not easy to communicate with the object. Accordingly, in such a case, the manager may take an immediate action for a communication state with the relevant object and the like.

Further, while the loss data 615 are stored in the loss database 650 in FIG. 6, the loss data 650 may be stored in the abnormal database 150 in FIG. 4 without constructing the loss database 650 separately according to the need of those skilled in the art.

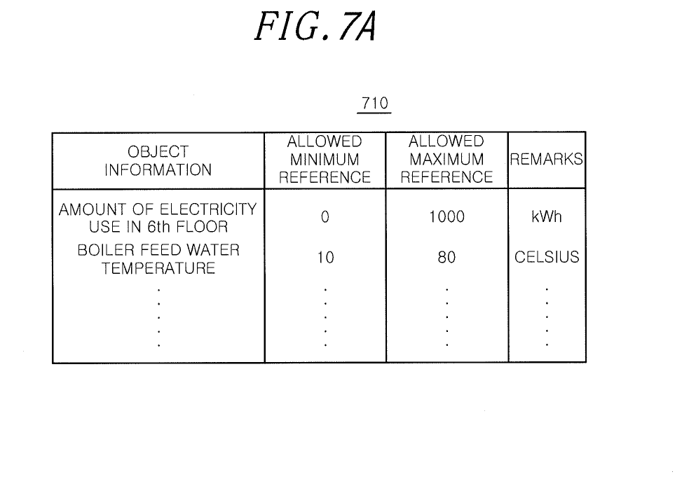

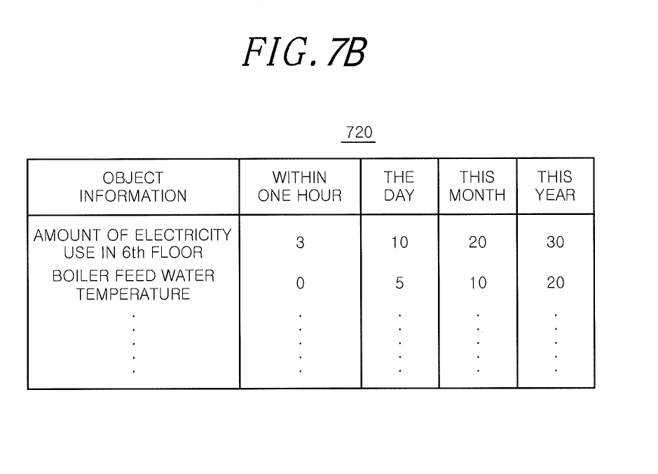

FIGS. 7A and 7B are conceptual diagrams illustrating profiles used in a reference database in accordance with an exemplary embodiment of the present invention.

Referring to FIGS. 7A and 7B, a first profile 710 is an example of an allowed minimum reference and an allowed maximum reference to determine whether an error occurs for each object, and a second profile 720 is an example of allowed loss number for each object.

The first or second profile may be set for each object, and particularly it may be set hourly in case of the allowed loss number. For example, as illustrated in the drawing, the allowed loss number may be set within one hour, daily, monthly, and yearly.

Meanwhile, the profile may be added, changed or deleted by the manger depending on the importance of the object and environment state. Further, the profile may also be added, changed or deleted by a predetermined program.

Although not illustrated in FIGS. 7A and 7B, a profile for a monitoring period to monitor whether the state data are received may also be set for each object, and it may be added, changed or deleted by the manager or a predetermined program.

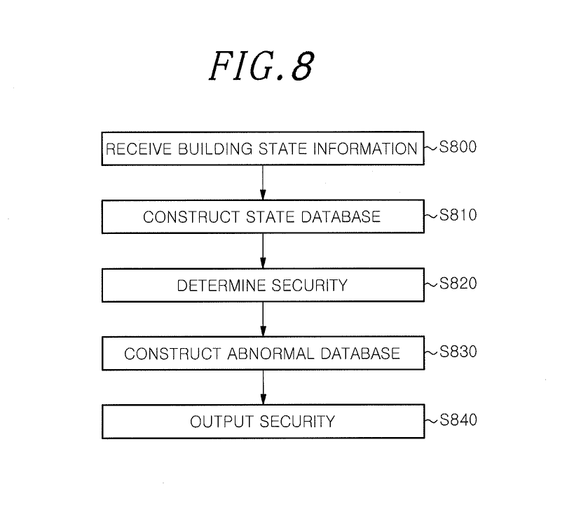

FIG. 8 is a flowchart illustrating a building state monitoring process in accordance with an exemplary embodiment of the present invention.

Hereafter, an exemplary embodiment of the present invention will be described in detail with reference to FIGS. 1 to 8.

First, the building state monitoring apparatus 100 receives state data of the building from a plurality of objects to measure a building state in an operation 5800.

Next, the building state monitoring apparatus 100 constructs a state database based on the state data in an operation 5810.

Next, the building state monitoring apparatus 100 determines a security in order to extract abnormal information that is determined to be in an abnormal scope among the state data in an operation 5820.

At this time, the building state monitoring apparatus 100 constructs the abnormal database 150 when determined to be abnormal in an operation S830, and outputs the data stored in the abnormal database 150 to the manager in an operation 5840.

As reviewed above, in the apparatus and method for monitoring a building state in accordance with an exemplary embodiment of the present invention, since it is possible to immediately report a building manager when state data provided from a plurality of building facilities are out of a reference value or a normal pattern, it is possible to immediately arrange for maintenance to a failure occurrence or a short circuit situation, thereby effectively managing building facilities and building consumption energy.

The above described exemplary embodiments of the present invention may be embodied in a format of program instructions performed by a variety of computer components and stored in a computer readable storage medium. The computer readable storage medium may include program instruction, data files, and data structures in a sole or a combined manner. The program commands stored in the computer readable storage medium may be something specifically designed and constructed for the embodiments of the present invention or may be something known to those skilled in the art and available. Examples of the computer readable storage medium may include, but not limited to, hardware devices that specifically constructed to store and execute program instructions, such as magnetic media, optical storage media including CD-ROMs and DVDs, magneto-optical media including floptical disks, and Read-Only Memory (ROM), Random Access Memory (RAM) and flesh memory devices. Examples of program instructions include high-level language codes that can be executed by a computer using an interpreter or the like as well as machine language codes formed by a compiler. The hardware devices may be constructed to operate as one or more software modules in order to perform the process in accordance with the present invention, and the converse is also permitted.

While the present invention has been shown and described with reference to specific matters such as the concrete elements and the definitive embodiments and drawings, it should be noted by those skilled in the art that these are provided only for the general understanding of the present invention. Therefore, the present invention may not be limited to the foregoing embodiments and may be changed and modified in various forms from the above description.

Therefore, the spirit of the present invention is defined by the appended claims rather than by the foregoing embodiments, and all changes and modifications that fall within the bounds of the claims, or equivalents of such bounds are intended to be embraced by the scope of the present invention.

What is claimed is:

1. An apparatus for monitoring a building state, the apparatus comprising:
a receiver configured to receive state data of a building from a plurality of sensors that are used to measure a building state;
a state database configured to store the state data;
a reference database configured to store a reference to determine whether the state data are abnormal;
a security determining unit configured to extract abnormal data determined to be in an abnormal scope among the state data; and
an abnormal database configured to store the abnormal data.

2. The apparatus of claim 1, wherein the reference database further comprises an allowed minimum reference and an allowed maximum reference predetermined for the state data;
wherein the security determining unit further comprises an error verifying unit to determine an error when the state data are less than the allowed minimum reference or exceed the allowed maximum reference; and
wherein the abnormal database further comprises error data determined to be erroneous among the state data.

3. The apparatus of claim 2, wherein the security determining unit further comprises an error number calculator to calculate an accumulated error number that the state data are determined as error data; and wherein the abnormal database further comprises the accumulated error number.

4. The apparatus of claim 1, wherein the reference database further comprises a monitoring period which monitors whether the state data are received;
wherein the security determining unit comprises loss number accumulating unit to calculate an accumulated loss number, the accumulated loss number being the number of state data that are not received within the monitoring period; and
wherein the abnormal database further comprises the accumulated loss number.

5. The apparatus of claim 3, further comprising a security output unit to transmit at least one of the error data and the accumulated error number stored in the abnormal database to a manager of the building.

6. The apparatus of claim 4, wherein the reference database further comprises an allowed loss time indicating a maximum value in which the accumulated loss number are permitted; and
wherein the security determining unit further comprises a loss number verifying unit which determines whether the accumulated loss number exceed the allowed loss number.

7. The apparatus of claim 6, wherein the allowed loss number are differently decided depending on at least one period.

8. The apparatus of claim 2, wherein at least one of the allowed minimum reference and the allowed maximum reference is added, deleted or changed based on a predetermined process.

9. The apparatus of claim 6, wherein at least one of the monitoring period or allowed loss number is added, deleted or changed based on a predetermined process.

10. The apparatus of claim 1, wherein the state data comprises at least one of building facility state information, building interior and exterior environment information, and building consumed energy pattern information.

11. A method for monitoring a building state, the method comprising:
receiving state data of a building from a plurality of sensors that are used to measure a building state;
constructing a state database configured to store the state data;
constructing a reference database configured to store a reference to determine whether the state data are abnormal;
determining a security to extract abnormal data determined to be in an abnormal scope among the state data; and
constructing an abnormal database configured to store the abnormal data.

12. The method of claim 11, wherein the reference database further comprises an allowed minimum reference and an allowed maximum reference predetermined for the state data;
wherein said determining a security further comprises determining an error when the state data are less than the allowed minimum reference or exceed the allowed maximum reference; and
wherein the abnormal database further comprises error data determined to be erroneous among the stat data.

13. The method of claim 12, wherein said determining a security further comprises calculating an accumulated error number, which determine the state data as error data; and
wherein the abnormal database further comprises the accumulated error number.

14. The method of claim 11, wherein the reference database further comprises a monitoring period which monitors whether the state data is received;
wherein said determining a security further comprises accumulating loss number to calculate an accumulated loss number, the accumulated loss number being the number of the state data that are not received within the monitoring period; and
wherein the abnormal database further comprises the accumulated loss number that is accumulated in the accumulating loss number.

15. The method of claim 11, further comprising transmitting at least one of the error data and an accumulated error number stored in the abnormal database to a manager of the building.

16. The method of claim 14, wherein the reference database further comprises an allowed loss number indicating a maximum value in which the accumulated loss number is permitted; and
wherein said determining a security further comprises determining whether the accumulated loss number exceeds the allowed loss number.

17. The method of claim 16, wherein the allowed loss number is differently decided depending on at least one period.

18. The method of claim 12, wherein at least one of the allowed minimum reference and the allowed maximum reference is added, deleted or changed based on a predetermined process.

19. The method of claim 16, wherein at least one of the monitoring period or the allowed loss number is added, deleted or changed based on a predetermined process.

20. The method of claim 11, wherein the state data comprises at least one of building facility state information, building interior and exterior environment information, and building consumed energy pattern information.
